(19) United States
(12) Patent Application Publication
(10) Pub. No.: US 2015/0226844 A1
(43) Pub. Date: Aug. 13, 2015

(54) METHOD FOR CHECKING A SURROUNDINGS SENSOR DEVICE, REFERENCE SOUND SOURCE, AND CORRESPONDING SURROUNDINGS SENSOR DEVICE

(71) Applicant: Robert Bosch GmbH, Stuttgart (DE)

(72) Inventors: Andre Gerlach, Leonberg-Hoefingen (DE); Florian Haug, Ditzingen (DE); Christopher Brown, Stuttgart (DE)

(21) Appl. No.: 14/422,129

(22) PCT Filed: Jul. 24, 2013
(86) PCT No.: PCT/EP2013/065603

§ 371 Date: Feb. 17, 2015

(30) Foreign Application Priority Data
Aug. 17, 2012 (DE) 102012214657.1

(51) Int. Cl. G01S 7/52

(52) U.S. Cl. CPC G01S 7/52004

(57) ABSTRACT

A method for checking a surroundings sensor device including the following: transmitting a reference sound signal by a reference sound source; detecting the reference sound signal by a receiving device of the surroundings sensor device; and calibrating the surroundings sensor device by a computer unit of the surroundings sensor device based on the detected reference sound signal for checking the surroundings sensor device.

### FIELD OF THE INVENTION

The present invention relates to a method for checking a surroundings sensor device, a reference sound source, and a corresponding surroundings sensor device.

### BACKGROUND INFORMATION

German patent document DE 40 235 38 A1 refers to a collision warning device, in particular for avoiding collisions with stationary obstacles in the vicinity of a motor vehicle, having a device for contactless distance measurement, at least two ultrasonic sensors being situated at a predefined spacing for the collision warning device.

In the device described there, an evaluation is provided for the transit times between the transmission of each ultrasonic signal and the reception of a reflected ultrasonic signal, the ultrasonic signal of the same and the other ultrasonic sensor being respectively used.

The publication entitled “Fast Bearing Measurement with a Single Ultrasonic Transducer” by T. Yata, L. Kleeman, and S. Yuta, appearing in the International Journal of Robotics Research, Volume 17, Number 11 on pages 1202-1213 published in 1998, describes a method and a device for ultrasonic scanning. In the method discussed there, a single ultrasonic transducer, which is operated in an ultrasonic pulse-echo detection mode, is used to extract information.

Patent document FR 281 797 3 A1 discusses a method for detecting the position of objects for assistance during parking of a motor vehicle, the method being carried out using a network of ultrasonic sensors on the motor vehicle.

### SUMMARY OF THE INVENTION

The present invention creates a method for checking a surroundings sensor device as described herein, a reference sound source for transmitting a reference sound signal having the features described herein, and a surroundings sensor device as described herein.

The idea of the present invention is that a system monitoring and calibration may be carried out for the surroundings sensor device by using a reference sound source or a reference backscatter body.

In comparison to a self-diagnosis, which supplies electrical signals, the entire system may be included in the system monitoring and calibration. Using the sonic measurement, all receiving transducers may be checked and calibrated, including the amplifier and analog-digital converter channels of the transmission and/or receiving device.

Advantageous specific embodiments and refinements arise from the further descriptions herein and also from the description with reference to the figures.

According to one specific embodiment of the present invention, the calibration of the surroundings sensor device includes a calibration of the receiving device of the surroundings sensor device. This enables a simple and safe check of the receiving device.

According to one specific embodiment of the present invention, the calibration of the surroundings sensor device includes a calibration of the computer unit of the surroundings sensor device. This enables a simple and safe check of the computer unit.

According to one specific embodiment of the present invention, the calibration of the surroundings sensor device includes a detection of the position of the reference sound source. Thus, the function of the surroundings sensor device may be checked directly.

According to one specific embodiment of the present invention, a backscatter body is used as the reference sound source and a sound signal is transmitted from a transmission device of the surroundings sensor device to the reference sound source. The use of a reference backscatter body has the advantage over a reference sound source that it is an inexpensive and simple passive body, and also that the sound transmitter of the surroundings sensor device is included in the check.

According to one specific embodiment of the present invention, a harmonic sound signal, a burst signal, a sweep signal, or a pulse signal is used as the reference sound signal.

According to one specific embodiment of the present invention, a plurality of reference sound signals with different characteristics and/or in chronological sequence is used.

The embodiments and refinements described may be arbitrarily combined with each other.

Additional possible embodiments, refinements, and implementations of the present invention also include combinations not explicitly listed of features of the present invention described previously or subsequently with regard to the exemplary embodiments.

The accompanying drawings should convey a further understanding of the specific embodiments of the present invention. They illustrate specific embodiments and serve for the explanation of principles and concepts of the present invention in conjunction with the description.

Other specific embodiments and many of the advantages listed arise with regard to the drawings. The elements of the drawings represented are not necessarily shown to scale with each other.

### BRIEF DESCRIPTION OF THE DRAWINGS

FIG. 1 shows a schematic representation of a surroundings sensor device according to one specific embodiment of the present invention.

FIG. 2 shows a schematic representation of a flow chart of a method for checking a surroundings sensor device according to yet another specific embodiment of the present invention.

### DETAILED DESCRIPTION

In the figures of the drawing, the same reference numerals designate identical or functionally identical elements, components, or method steps, insofar as nothing is indicated to the contrary.

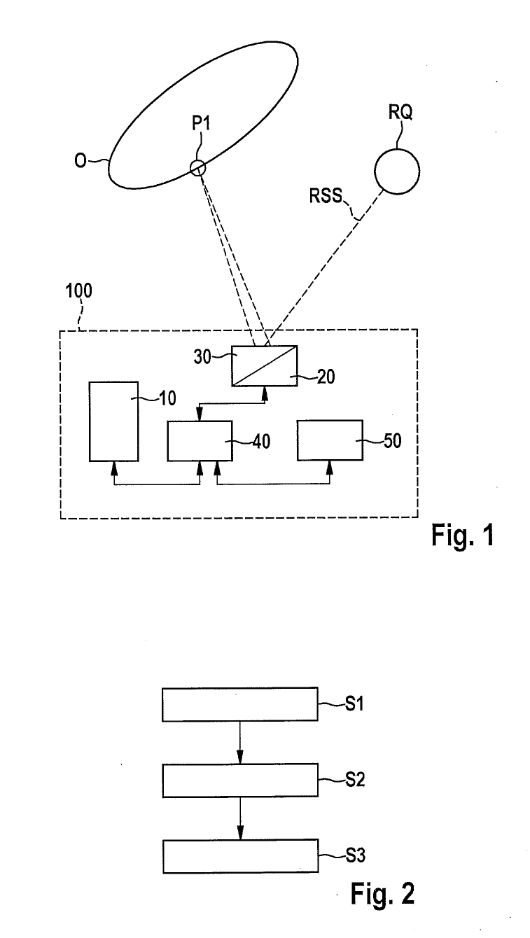

FIG. 1 shows a schematic representation of a surroundings sensor device according to one specific embodiment of the present invention.

Surroundings sensor device 100 includes a memory device 10, a receiving device 20, a transmission device 30, and a computer unit 40.

Receiving device 20 is configured to detect reference sound signal RSS transmitted by reference sound source RQ. Transmission device 30 is configured, for example, to convert electrical signals from computer unit 40 into sound and to transmit them.

Memory device 10 is configured to provide operating data to surroundings sensor device 100. The operating data may thereby include data regarding the most recently carried out calibration or check of surroundings sensor device 100. In addition, the operating data stored in memory device 10 may also include data regarding a position of reference sound source RQ to be determined during calibration of surroundings sensor device 100.

Computer unit 40 is configured to calibrate surroundings sensor device 100 using the detected reference sound signal RSS, and thereby check it.

Receiving device 20, memory device 10, and computer unit 40 are, for example, implemented as network-connected computer units.

Computer unit 40 and memory device 10 are, for example, configured as one processor unit or as another electronic data processing unit.

Display device 50 of surroundings sensor device 100 is, for example, coupled to computer unit 40 and is provided for displaying the function of surroundings sensor device 100.

Display device 50 may be configured as a liquid crystal display or as a liquid crystal monitor, the function of which is based on the fact that liquid crystals influence the polarization direction of light when a certain level of electrical voltage is applied.

Receiving device 20 is, for example, configured as a microphone or as a piezoelectric sound transducer, or as another sound transducer, which converts airborne sound as sound pressure oscillations into corresponding electrical voltage variations as a microphone signal.

Transmission device 30 is, for example, configured as an electrodynamic loudspeaker with a central drive or as a piezoelectric sound transducer or as an electrostatic loudspeaker or as a ferroelectric loudspeaker or as an electromagnetic loudspeaker or as another loudspeaker.

Computer unit 40 is configured for example as a microcontroller, also known as a μcontroller, which, in addition to a processor, also combines units for peripheral functions on one chip.

Surroundings sensor device 100 may determine the distance of a reflection point P1 to object O using a transit time of the sound pulse measured by computer unit 40.

Optionally, the localization of reflection point P1 of object O may be carried out by surroundings sensor device 100 via a method based on a frequency shift or on a trilateration, the direction and the complete spatial coordinates of reflection point P1 being determined with the aid of multiple spatially separated receiving devices 20 and/or multiple spatially separated transmission devices 30.

The maximum transit time of a sound pulse in the surroundings is referred to as the burst transit time of surroundings sensor device 100 and determines the maximum range for object detection by surroundings sensor device 100.

Reference sound source RQ or the backscatter body may be easily integrated into the base or charging station of a robot having surroundings sensor device 100. The backscatter body may have a solid material, such as metal or plastic, and be configured with a defined geometry, such as a spherical or cylindrical shape or as a triple reflector. Ultrasonic-based surroundings sensor device 100 thereby uses the integrated transmission device 30 to spotlight the backscatter body.

If reference sound source RQ or the backscatter body is positioned too close to the surroundings sensor device for a system monitoring and calibration, the robot equipped with surroundings sensor device 100 may travel a defined path in order to distance itself from the base or charging station.

Surroundings sensor device 100 and reference sound source RQ are suitable for ultrasonic-based applications, which process directional information and use array systems, such as a surroundings sensing for robots, also for autonomously functioning lawn mowers, vacuums, transport robots, or other moving robots.

FIG. 2 shows a schematic representation of a flow chart of a method for checking a surroundings sensor device according to yet another specific embodiment of the present invention.

As a first method step, transmission S1 of a reference sound signal RSS is carried out by reference sound source RQ.

Reference sound signal RSS may be configured as a limited number of oscillations at a fixed frequency with a certain duration. Reference sound signal RSS may likewise be configured as a harmonic sound signal, a burst signal, a sweep, signal, or a pulse signal. A periodic signal may be used here as a sweep signal, which changes its frequency from an initial value to an end value within a defined time period.

As a second method step, detection S2 of reference sound signal RSS is carried out by a receiving device 20 of surroundings sensor device 100.

As a third method step, calibration S3 of surroundings sensor device 100 is carried out by computer unit 40 of surroundings sensor device 100 using the detected reference sound signal RSS for checking surroundings sensor device 100.

The individual method steps of the method for checking a surroundings sensor device may be repeated arbitrarily, for example iteratively or recursively.

Although the present invention has been described above based on exemplary embodiments, it is not limited thereto, but instead is modifiable in multiple ways. In particular, the present invention may be altered or modified in manifold ways without deviating from the core of the present invention.

1-9. (canceled)

10. A method for checking a surroundings sensor device, the method comprising:
transmitting a reference sound signal by a reference sound source;
detecting the reference sound signal by a receiving device of the surroundings sensor device; and
calibrating, using a computer unit of the surroundings sensor device, the surroundings sensor device based on the detected reference sound signal for checking the surroundings sensor device.

11. The method of claim 10, wherein the calibration of the surroundings sensor device includes a calibration of the receiving device of the surroundings sensor device.

12. The method of claim 10, wherein the calibration of the surroundings sensor device includes a calibration of the computer unit of the surroundings sensor device.

13. The method of claim 10, wherein the calibration of the surroundings sensor device includes ascertaining a position of the reference sound source.

14. The method of claim 10, wherein a backscatter body is used as the reference sound source and a sound signal is transmitted to the reference sound source by a transmission device of the surroundings sensor device.

15. The method of claim 10, wherein the reference sound signal (RSS) is a harmonic sound signal, a burst signal, a sweep signal, or a pulse signal.

16. The method of claim 10, wherein there is a plurality of reference sound signals (RSS) with different characteristics and/or in a chronological sequence.

17. A reference sound source for checking a surroundings sensor device, comprising:
a reference sound source to transmit a reference sound signal (RSS);
a receiving device to detect the reference sound signal, wherein the receiving device is part of the surroundings sensor device; and
a computer unit for checking the surroundings sensor device by calibrating the surroundings sensor device based on the detected reference sound signal, wherein the computer unit is part of the surroundings sensor device.

18. A surroundings sensor device, comprising:
a receiving device to detect a reference sound signal (RSS), which is transmitted from a reference sound source; and
a computer unit to check the surroundings sensor device by calibrating the surroundings sensor device based on the detected reference sound signal (RSS).
